(19) United States
(12) Patent Application Publication
(10) Pub. No.: US 2010/0068134 A1
(43) Pub. Date: Mar. 18, 2010

(54) METHODS OF ENHANCING KINETIC PROPERTIES OF HYDROGEN STORAGE MATERIALS BY SELF-CATALYSIS

(75) Inventors: Andrea Sudik, Dearborn, MI (US); Jun Yang, Ann Arbor, MI (US); Donald J. Siegel, Ann Arbor, MI (US); Christopher Mark Wolverton, Evanston, IL (US)

Correspondence Address: BROOKS KUSHMAN P.C./FGTL, 1000 TOWN CENTER, 22ND FLOOR, SOUTHFIELD, MI, 48075-1238, US

(73) Assignee: Ford Global Technologies, LLC, Dearborn, MI (US)

(21) Appl. No.: 12/233,246

(22) Filed: Sep. 18, 2008

(51) Int. Cl. C01B 3/00

(52) U.S. Cl. 423/658.2

(57) ABSTRACT

Methods of enhancing the kinetic properties of solid-state hydrogen storage materials are disclosed. The methods of the present invention comprise a process of utilizing built-in, ancillary reactions to effectually catalyze primary hydrogen storage reactions. This self-catalysis process gives rise to novel mechanisms for solid-state hydrogen storage compositions that benefit from enhanced kinetic properties, thereby increasing the usefulness of hydrogen storage technologies. The methods of enhancing the kinetic properties of hydrogen storage compositions by implementing a self-catalyzing reaction mechanism generally include formulating a hydrogen desorption pathway in a hydrogen storage composition, the pathway including a hydrogen releasing reaction and an ancillary reaction; and selecting the ancillary reaction to produce a product that serves to enhance the kinetic properties of the hydrogen releasing reaction.

### BACKGROUND

1. Technical Field

The present invention relates to methods of enhancing the kinetic properties of hydrogen storage materials by a process of utilizing one or more built-in, ancillary reactions to catalyze a primary hydrogen storage reaction.

2. Background Art

The widespread adoption of hydrogen as a fuel for vehicles requires effective and efficient hydrogen storage systems. Existing storage technologies encompass both compressed gas or liquid hydrogen storage and so-called materials-based hydrogen storage. Systems based on compressed hydrogen are hindered by low hydrogen densities. Conversely, hydrogen storage materials, in which hydrogen is chemically or physically bound to a solid or liquid compound, can theoretically achieve the densities required for effective and efficient on-board hydrogen storage. Current research focuses on both hydrogen storage compositions and methods for increasing their effectiveness.

Materials-based hydrogen storage relies on the ability of certain elements or compounds to favorably interact with atomic or molecular hydrogen. This hydrogen-to-material interaction enables hydrogen to be packed even closer together than in liquid hydrogen, making hydrogen storage in materials debatably the most promising means to surpassing current technologies based compressed or liquefied hydrogen. A hydride is any neutral or ionic chemical species that contains hydrogen. Hydrogen storage compositions are often composed of one or more compounds selected from four main classes: conventional and binary metal hydrides, complex metal hydrides, chemical hydrides, and sorbent systems. Conventional and binary metal hydrides—herein referred to simply as conventional and binary hydrides—are compounds in which negative hydrogen is bonded ionically or covalently to a metal, or is present as a solid solution in the lattice of one or more metals (e.g. LiH, MgH₂, LaNi₅H₇, etc.). Complex metal hydrides—herein referred to simply as complex hydrides—are a class of ionic hydrogen-containing compounds, which are optimally composed of 1 or more light-weight alkali or alkali earth metal cations and hydrogen-containing complex anions (e.g. LiBH₄, NaAlH₄, LiNH₂, Li₄(NH₂) (BH₄), etc.). Chemical hydrides are hydrogen-containing solid or liquid hydrides that can be heated directly, passed through a catalyst-containing reactor, or combined with another chemical to produce hydrogen (e.g. NH₃BH₃, Li(NH₂) (BH₄), N-ethylcarbazole, etc.). Sorbent systems are porous lightweight materials that possess very high surface areas to which molecular hydrogen can physically adsorb (i.e. physisorption mechanism) or which can be exposed to a hydrogen dissociation catalyst to induce storage of atomic hydrogen (often termed ‘spillover’) (e.g. MOF-177, IRMOF-1, IRMOF-8/bridged-Pt/C). All classes of hydrogen storage materials have the potential to store large amounts of hydrogen by weight (up to 18.5 wt % for LiBH₄) and/or by volume (up to 112 gL⁻¹ for MgH₂). These hydrogen storage properties are comparable to the hydrogen content in gasoline (15.8 wt % and 112 gL⁻¹). Unfortunately, all classes of hydrogen storage materials suffer from thermodynamic impediments, undesired reaction products, kinetic deficiencies, and gravimetric and/or volumetric capacity limitations that inhibit their widespread use in mobile hydrogen storage applications. Some of the specific problems include: a) impractical temperatures and/or pressures for hydrogen release/uptake; b) low rates of both hydrogen release and uptake; c) decomposition pathways involving the release of undesirable products; and d) an inability to reversibly store hydrogen at acceptable temperatures and pressures.

Following recent discoveries that have shown the ability to substantially improve the thermodynamics, kinetics, and reversibility of hydrogen storage materials through the use of reactive mixtures and catalytic doping, current research displays a renewed interest in these materials. Research has shown that some reactive mixtures, or composites, of two hydrogen storage materials such as LiNH₂/MgH₂, LiNH₂/LiBH₄, MgH₂/LiBH₄ and NH₃BH₃/LiH in comparison to their constituent compounds, exhibit improved thermodynamic properties, higher hydrogen purity, and, in some cases, reversibility. These hydrogen storage composites have not, however, been able to overcome all of the limitations. The problem of prohibitive kinetic limitations in the reaction pathways of these composites still exists.

Although catalytic doping has been used to mitigate the kinetic limitations of some composites, the process of identifying potential catalysts requires expensive time consuming trial-and-error searches. Furthermore, on its own, catalytic doping has not yet shown the ability to effectively overcome the current limitations of hydrogen storage materials. Accordingly, there is a need for additional methods of enhancing the kinetic properties of hydrogen storage compositions. It is therefore an object of the present invention to effectively address kinetic limitations without the need for expensive time consuming trial-and-error searches.

### SUMMARY

In view of the foregoing, the present invention aims to improve upon the known prior art by providing novel methods of enhancing the kinetic properties of hydrogen storage compositions. The methods of the present invention comprise a process of utilizing a built-in, ancillary reaction to effectually catalyze a primary hydrogen storage reaction. When applied to hydrogen storage compositions, the process of utilizing one or more built-in, ancillary reactions to enhance the kinetic properties of one or more primary hydrogen storage reactions effectuates a cascading reaction mechanism that is herein referred to as “self-catalyzing.” The self-catalyzing reaction mechanism can be used to mitigate the kinetic limitations of hydrogen storage materials.

According to at least one embodiment of the present invention, a method of enhancing the kinetic properties of a hydrogen storage composition by implementing a self-catalyzing reaction mechanism is provided. The method comprises formulating a hydrogen desorption pathway in a hydrogen storage composition, the pathway including a hydrogen releasing reaction and an ancillary reaction; and selecting the ancillary reaction to produce a product or effect that serves to enhance the kinetic properties of the hydrogen releasing reaction.

In at least one embodiment of the method, the selecting step comprises selecting the ancillary reaction to produce heat for enhancing the kinetic properties of the hydrogen releasing reaction.

In yet another embodiment of the method, the selecting step comprises selecting the ancillary reaction to produce a plurality of product nucleation seeds for enhancing the kinetic properties the hydrogen releasing reaction.

In still yet another embodiment of the method, the selecting step comprises selecting the ancillary reaction to produce a homogenizing agent for enhancing the kinetic properties of the hydrogen releasing reaction.

In still yet another embodiment of the method, the selecting step comprises selecting the ancillary reaction to produce a disbursed catalyst or a microstructural facilitator to enhance the kinetic properties of the hydrogen releasing reaction.

In a further embodiment of the invention, the method of enhancing the kinetic properties of a hydrogen storage composition by implementing a self-catalyzing reaction mechanism comprises formulating a hydrogen absorption pathway in a hydrogen storage composition, the pathway including a hydrogen uptake reaction and an ancillary reaction; and selecting the ancillary reaction to produce a product or effect that serves to enhance the kinetic properties of the hydrogen uptake reaction.

In at least one embodiment of the method, the selecting step comprises selecting the ancillary reaction to produce heat for enhancing the kinetic properties of the hydrogen uptake reaction.

In yet another embodiment of the method, the selecting step comprises selecting the ancillary reaction to produce a plurality of product nucleation seeds for enhancing the kinetic properties the hydrogen uptake reaction.

In still yet another embodiment of the method, the selecting step comprises selecting the ancillary reaction to produce a homogenizing agent for enhancing the kinetic properties of the hydrogen uptake reaction.

In still another embodiment of the method, the ancillary reaction products a well disbursed catalyst.

In still yet another embodiment of the method, the ancillary reaction produces a microstructural facilitator.

According to certain aspects of the present invention, the hydrogen storage composition comprises hydrogen storage materials selected from the group consisting of conventional and binary hydrides and complex hydrides.

In at least one embodiment, the hydrogen releasing reaction or the hydrogen uptake reaction is reversible.

According to another embodiment of the present invention, the method of enhancing the kinetic properties of a hydrogen storage composition by implementing a self-catalyzing reaction mechanism comprises formulating a hydrogen pathway in a hydrogen storage composition, the pathway including a hydrogen releasing reaction, a hydrogen uptake reaction, and a plurality of ancillary reactions; and selecting at least one of the ancillary reactions to produce a product or effect that serves to enhance the kinetic properties of at least one of the hydrogen releasing reaction or the hydrogen uptake reaction.

These and other aspects of the present invention will be readily understood by one of ordinary skill in the art in view of the following detailed description of the preferred embodiments of the present invention.

### BRIEF DESCRIPTION OF THE DRAWINGS

FIG. 1 depicts the composition of the gas released from the ternary composite while heating at 5° C./min in a flow of 100 sccm Ar as plotted in comparison with the binary composites;

FIG. 2 depicts the results for five charge/discharge cycles showing that the as-prepared material rapidly releases approximately 3.0 wt % hydrogen within 20 minutes;

FIG. 3 depicts the reversible isothermal kinetic desorption profiles for the second desorption cycle (to 1 bar) collected at 140°, 150°, 160°, and 180° C.;

FIG. 4 depicts the remaining hydrogen liberated in a second step at higher temperatures for a total hydrogen capacity of 8.2 wt %;

FIG. 5 depicts temperature—programmed—desorption mass spectrometry (TPD-MS) data under constant heating rate and carrier gas flow (5° C./min, 100 sccm Ar flow);

FIG. 6 shows the species involved in various desorption reactions identified through phase composition studies that are carried out for identically prepared samples that are desorbed to varying degrees to 1 bar hydrogen by heating at 5° C./min in a water displacement apparatus;

FIG. 7a shows the raw PXRD data as a function of temperature (25° to 45° C.);

FIG. 7b shows the two-dimensional contour plot of raw PXRD data in relation to FIG. 7a;

FIG. 7c shows the phase assemblage as a function of temperature; and

FIG. 8 shows a summary of a set of proposed reactions, taking into account the observed and theoretical hydrogen capacity for each step, the reversible amount of stored hydrogen, and the phase compositions (obtained from both quenched/static and in situ PXRD and IR).

### DETAILED DESCRIPTION

As required, detailed embodiments of the present invention are disclosed herein. However, it is to be understood that disclosed embodiments are merely exemplary of the invention that may be embodied in various alternative forms. Specific structural and functional details disclosed herein are not to be interpreted as limiting, but merely as a representative basis for the claims and/or a representative basis for teaching one skilled in the art to variously employ the present invention. Moreover, except where otherwise expressly indicated, all numerical quantities in this description and in the claims indicating amounts of materials or conditions of reactions and/or use are to be understood as modified by the word “about” in describing the broadest scope of the invention. Practice within the stated numerical limit is generally preferred. Also, unless expressly stated to the contrary, “parts of” and ratio values are by mole fraction and percent by weight and the description of a group or class of materials as suitable or preferred for a given purpose in connection with the invention implies that mixtures of any two or more members of the group or class may be equally suitable or preferred.

The methods of the present invention enhance the kinetic properties of hydrogen storage compositions by implementing a self-catalyzing reaction mechanism that is characterized by a cascading or coupled set of chemical reactions in which an ancillary reaction effectually catalyzes a primary hydrogen storage reaction. The primary hydrogen storage reaction may comprise a hydrogen releasing reaction, a hydrogen uptake reaction, or a combination of the two in the form of a reversible hydrogen releasing/uptake reaction. In this description, the term “primary hydrogen storage reaction” is often used to generally illustrate embodiments of the invention. It is to be understood that the term may refer to an embodiment of the invention that includes one or more hydrogen releasing reactions, one or more hydrogen uptake reactions, or a combination of the two either as a reversible hydrogen releasing/uptake reaction or as a plurality of reactions including both a hydrogen releasing reaction and a hydrogen uptake reaction.

By implementing a self-catalyzing reaction mechanism, the methods of the present invention have the ability to enhance the kinetic properties of hydrogen storage compositions by affecting hydrogen releasing reactions, hydrogen uptake reactions, and/or combinations of the two. Current research into hydrogen storage materials is heavily focused on compositions that are able to reversibly store hydrogen. Such compositions provide a primary hydrogen storage reaction capable of both desorbing and absorbing hydrogen in the same step of the reaction mechanism. Effective on-board storage of hydrogen, both in vehicle applications and others, requires hydrogen release and uptake in order to conform to the series of charging and discharging cycles required for continued use. The methods of the present invention can be readily applied to reversible hydrogen storage reactions by assisting the reaction in the forward direction, the reverse direction, or both.

Prohibitively high or low temperatures required for hydrogen release, low rates of both hydrogen release and uptake, and substantial activation energy barriers all adversely affect the kinetic properties of hydrogen storage materials and thereby limit their usefulness. The temperature at which hydrogen will desorb is in principle determined by thermodynamics alone and is directly related to the strength of the chemical or physical interaction with hydrogen within hydrogen storage materials, quantified by the reaction enthalpy (ΔH). For polymer electrolyte membrane fuel cell (PEM-FC) vehicles, it is desirable that the hydrogen desorption reaction have a ΔH roughly in the range of 20-50 kJ/mol.H₂, enabling fuel cell waste heat (T≈85° C.) to serve as the energy source for hydrogen release and to allow recharging of the material under modest temperature and pressure conditions. If this goal is to be reached, the prohibitive limitations of current hydrogen storage materials need to be mitigated.

The methods of the present invention mitigate the kinetic limitations by utilizing self-catalyzing reaction mechanisms. The kinetic properties of self-catalyzed hydrogen storage materials are enhanced relative to those of non-self-catalyzed reaction mechanisms. When applied to hydrogen storage materials, methods of self-catalysis result in faster reaction rates, lower desorption temperatures, and decreases in activation energies. These types of enhancements help to further the pursuit of effective on-board hydrogen storage systems.

As described in the Background, hydrogen storage compositions are often composed of conventional and binary hydrides (e.g. Lithium Hydride, Magnesium Hydride, etc.), complex hydrides (e.g. imides, alanates, borohydrides, amides, ammoniates, etc.), and combinations of the two. With the exception of metal-nitrogen compounds, these types of hydride sources can be represented by the general formula, Mᵢ^{j}XₖH₍ⱼᵢ₊₃ₖ₎ where M represents a cation from Group 1 or Group 2 of the Periodic Table with its average valence state, j, given as 1≦j≦2 and i≧0; X represents a second cation from Group 13 of the Periodic Table and k≧0; and H represents hydrogen; wherein i and j are selected so as to maintain electroneutrality of the compound. Hydride sources of this type include but are not limited to MgH₂, LiH, LiBH₄, Mg(BH₄)₂, NaAlH₄, Na₃AlH₆, and AlH₃. Exemplary metal-nitrogen compounds, on the other hand, can be represented by the general formula, M_{d}^{f} (NH_{g})_{(fg/2)} where M represents a cation from Group 1 or Group 2 of the Periodic Table with its average valence state, f, given as 1≦f≦2 and d≧0; N represents nitrogen, H represents hydrogen, and 1≦g≦2; wherein f and g are selected so as to maintain electroneutrality of the compound. Hydride sources of this type include but are not limited to LiNH₂, Li₂NH, Li₂Mg(NH)₂, Mg(NH₂)₂, NaNH₂, and Ca(NH₂)₂. The inclusion of the two preceding exemplary formulas is not meant to limit the scope of possible hydrogen storage material sources available and methods of the present invention. Further hydrogen storage material sources preferably include LaNi₅H₇, NH₃BH₃, Li₄(NH₂)3(BH₄), Li(NH₂) (BH3), Mg(BH₄) 2.(NH₃), MOFs, carbons, N-ethylcarbazole, Pt- or Pd-doped MOFs and carbons.

Individual sources, although viable hydrogen storage materials individually, can also be combined to form reactive composites of two or more compounds. Many reactive binary and ternary systems—hydrogen storage composites including mixtures of two and three distinct hydrogen storage compounds—have been shown by recent studies to offer hydrogen storage potentials that exceed those of individual components. The hydrogen storage compositions involved in the methods of the invention can readily comprise reactive composites. Examples of reactive composites preferred by methods of the present invention include but are not limited to LiNH₂/MgH₂, LiBH₄/MgH₂, LiNH₂/LiBH₄, LiNH₂/LiBH₄/MgH₂, CaH₂/LiBH₄, NH₃BH₃/LiH.

The set and specific order of reaction steps involved in a hydrogen storage reaction mechanism is herein referred to as a “hydrogen pathway.” The use of the term “hydrogen pathway” is used to encompass hydrogen desorption/release pathways, hydrogen absorption/uptake pathways, and/or reversible pathways including hydrogen release and uptake. The hydrogen pathways associated with the methods of the present invention must necessarily comprise at least two reaction steps broadly described as a primary hydrogen storage reaction and an ancillary reaction. The primary hydrogen storage reaction may comprise a hydrogen releasing reaction, a hydrogen uptake reaction, or a combination of the two in the form of a reversible hydrogen releasing/uptake reaction. The ancillary reaction can comprise any reaction other than the primary hydrogen storage reaction. It should be noted that the ancillary reaction may optionally include hydrogen release, hydrogen uptake, or both.

The methods of the present invention enhance the kinetic properties of hydrogen storage compositions by implementing a self-catalyzing reaction mechanism. The methods are based on mixing hydrogen storage materials in such a way as to formulate a hydrogen pathway that includes both a primary hydrogen storage reaction and an ancillary reaction. The ancillary reaction is selected to produce a product or effect that enhances the kinetic properties of the primary hydrogen storage reaction. The pathway is formulated by mixing or milling constituent hydrogen-containing compounds under certain conditions to develop both a primary hydrogen storage reaction and an ancillary reaction.

In at least one embodiment, the hydrogen pathway comprises a plurality of primary hydrogen storage reactions and one or more ancillary reactions. In certain embodiments, the hydrogen pathway comprises a plurality of reversible hydrogen release/uptake reactions and one or more ancillary reactions.

In at least one embodiment of the present invention, the primary hydrogen storage reaction is a hydrogen releasing reaction. In certain embodiments, the primary hydrogen storage reaction is a hydrogen uptake reaction, and in other embodiments the primary hydrogen storage reaction is a reversible hydrogen releasing/uptake reaction. Furthermore, certain embodiments of the present invention include constituent reactants of primary hydrogen storage reactions selected from the group consisting of conventional and binary hydrides and complex hydrides.

In at least one embodiment, the ancillary reaction includes reactants selected from the group consisting of conventional hydrides and complex hydrides. In certain embodiments, a plurality of ancillary reactions serve to enhance the kinetic properties of the primary hydrogen storage reaction. In other embodiments the ancillary reaction (or reactions) are selected to form a product (or products) or effect (or effects) that serve to enhance the kinetic properties of multiple primary hydrogen storage reactions.

In at least one embodiment, the ancillary reaction is selected to produce heat for enhancing the kinetic properties of the primary hydrogen storage reaction. The production of heat is used to facilitate the energy requirements of endothermic primary hydrogen storage reactions. By coupling an exothermic ancillary reaction with an endothermic primary hydrogen reaction the kinetic properties of the hydrogen storage composition are thus enhanced.

In at least one embodiment, the ancillary reaction is selected to produce nucleation seeds (or sites) for enhancing the kinetic properties of the primary hydrogen storage reaction. By providing nucleation seeds, the product of the primary hydrogen storage reaction, whether it constitutes a hydrogen release or uptake reaction, is more easily formed and the reaction is accordingly driven forward. This process results in decreased kinetic limitations for the hydrogen storage composition as a whole. In at least one embodiment the nucleation seeds are chemically identical to the product of the primary hydrogen storage reaction.

In at least one embodiment, the ancillary reaction is selected to produce a homogenizing agent for enhancing the kinetic properties of the primary hydrogen storage reaction. When an ancillary reaction is selected to provide a homogenized agent, kinetic barriers relating to mass transfer are minimized. In certain embodiments, the homogenizing agent may comprise an liquid phase with a melting temperature of about 25° C. to about 200° C. In other embodiments, the homogenizing agent may comprise an ionic liquid with a melting temperature of about 70° C. to about 120° C.

In certain embodiments, the well-dispersed product of an ancillary reaction serves as a catalyst in the primary hydrogen storage reaction via reduction of kinetic barriers.

In certain embodiments, the product of an ancillary reaction serves as a microstructural facilitator for the hydrogen storage reaction in preventing reactant/product grain growth as to aid in mass transfer.

Although embodiments of the present invention are commonly described herein as applicable to materials-based hydrogen storage systems for vehicle applications, the methods of the present invention may be applied to all types of applications designed to include materials-based hydrogen storage systems.

### EXAMPLE

An exemplary method is illustrated herein for enhancing the properties of various binary composites through the employment of a multi-component composite system or ternary composite system of three hydride compounds, 2 LiNH₂+LiBH₄+MgH₂.

The choice of the 2 LiNH₂+LiBH₄+MgH₂ stoichiometry is largely based on several factors: a) the constituent hydrides present relatively higher gravimetric/volumetric capacities, b) binary mixtures of these hydrides are among the well known and commonly selected hydrogen storage materials c) mixtures involving MgH₂ are known to suppress ammonia release from nitrogen-containing hydrides such as LiNH₂ and d) there is a stable, lightweight compound, lithium magnesium boron nitride (LiMgBN₂), which contains N:B:Mg in the ratio 2:1:1 which could serve as a potential dehydrogenated product phase.

The ternary composite may be analyzed with a summary of its principal hydrogen storage attributes in relation to those of the unary and binary components.

Lowered desorption temperatures: The ternary system rapidly releases hydrogen beginning at 150° C. (top panel), about 50-200° C. lower than the binary composites. The total capacity of the ternary composite is 8.2 wt %, indicating significantly improved kinetics and/or thermodynamics.

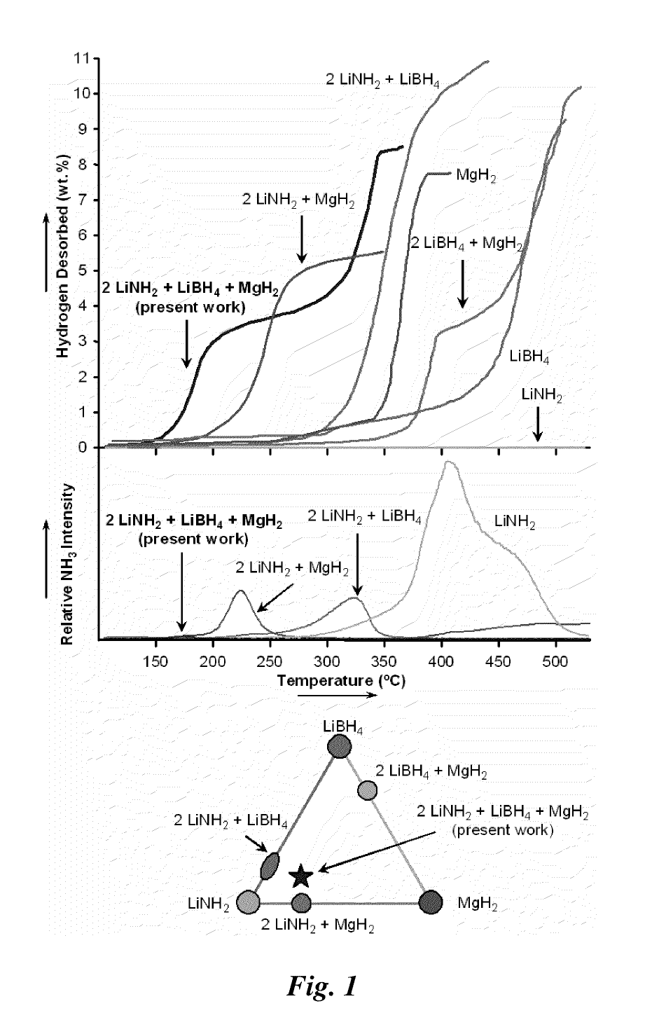

Improved hydrogen purity: The composition of the gas released from the ternary composite while heating at 5° C./min in a flow of 100 sccm Ar is plotted in comparison with the binary composites in the lower panel of FIG. 1.

For the ternary composite system, the amount of ammonia released is less than the 100 ppm detection limit of the instrument used, while the amount of ammonia released from the nitrogen-containing binaries is found to be more than an order of magnitude larger. No other volatile boron- and/or nitrogen-containing byproducts are detected throughout the desorption process.

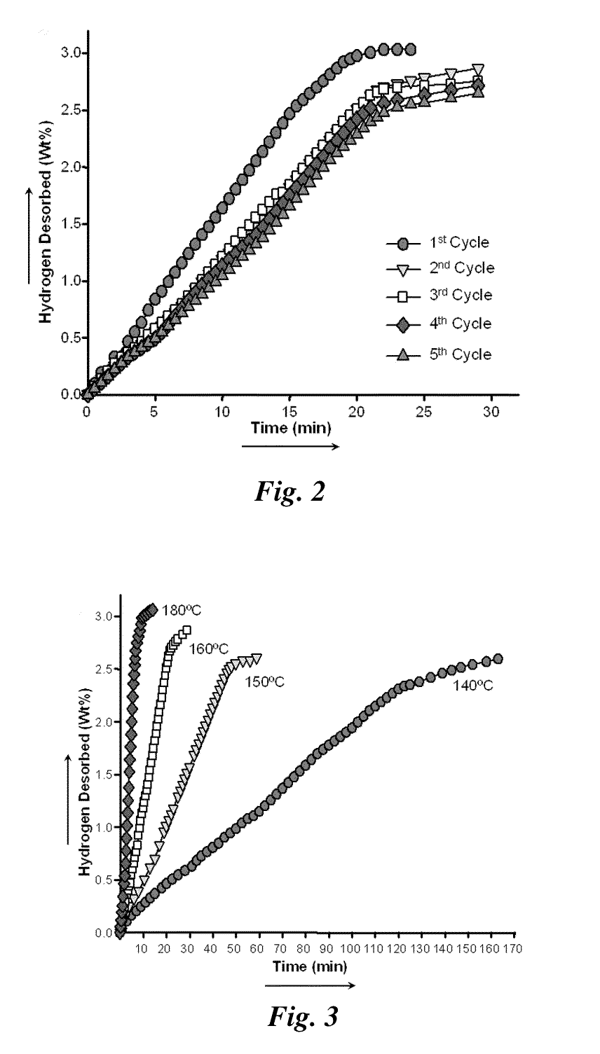

Reversibility: The reversible storage capacity and response to cycling are determined from a series of charge/discharge experiments on a Sievert's type PCT apparatus at 160° C. and charging (discharging) at 100 (1) bar. The results, depicted in FIG. 2, for five charge/discharge cycles, show that the as-prepared material rapidly releases approximately 3.0 wt % hydrogen within 20 minutes.

After recharging, the second through fifth desorption cycles consistently liberate ˜2.8 wt % hydrogen, a moderate-temperature reversible capacity that is among the best for solid-state hydrogen storage.

Kinetics: The reversible isothermal kinetic desorption profiles for the second desorption cycle (to 1 bar) are collected at 140°, 150°, 160°, and 180° C., see FIG. 3.

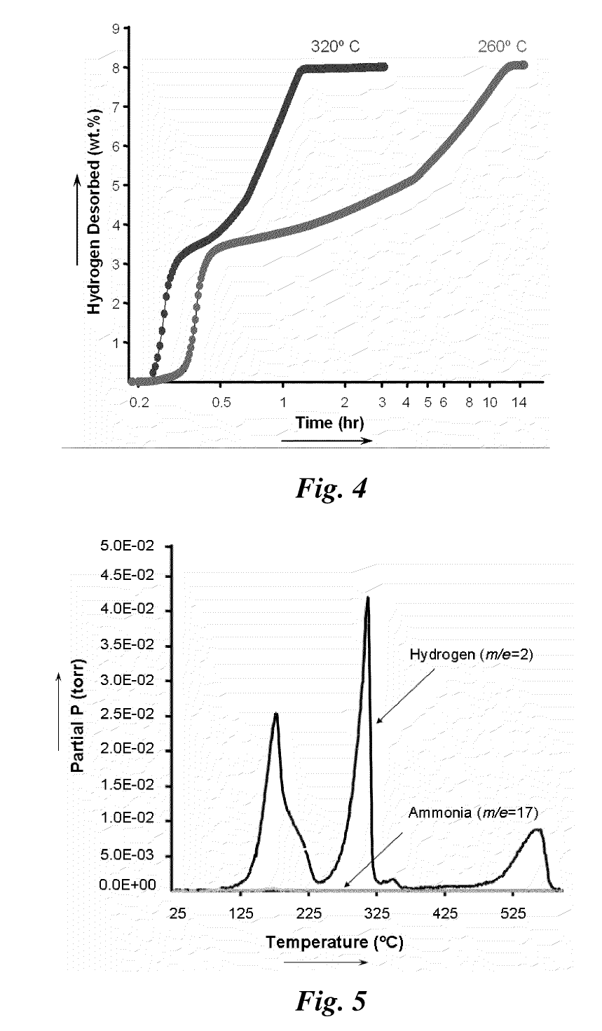

For this temperature range, the ternary composite is capable of desorbing more than 2.5 wt % hydrogen in time durations ranging from 10 minutes (180° C.) to 2.5 hours (140° C.). The remaining hydrogen is liberated in a second step at higher temperatures for a total hydrogen capacity of 8.2 wt %, see FIG. 4.

At both 260° C. and 320° C., the initial release of hydrogen is dramatically accelerated, with 3.2 wt % released within minutes, while the subsequent desorption steps are more influenced by temperature, reaching full desorption after 1.5 hr and 14 hr at 320° and 260° C., respectively.

The unique desorption behavior described above strongly suggests that the reaction mechanism(s) of the ternary composite is not a simple superposition of the known binary reactions. To understand its hydrogen-release characteristics, temperature—programmed—desorption mass spectrometry (TPD-MS) data under constant heating rate and carrier gas flow (5° C./min, 100 sccm Ar flow) are collected and depicted in FIG. 5.

Four distinct hydrogen release events occur with maxima at 180°, 190° (shoulder), 310°, and 560° C., and with an initial onset of desorption occurs at 110° C. TPD-MS data are also collected for the cycled/recharged material. The data suggests that the first steep desorption step (at 180° C.) in the as-prepared sample is no longer observed in the recharged sample. Instead, the peak temperature for the recharged sample is now shifted to the shoulder region for the fresh material (˜190° C.), indicating that the reaction corresponding to the shoulder is reversible, consistent with powder X-ray diffraction (PXRD) and infrared spectrometry (IR) analyses (described below).

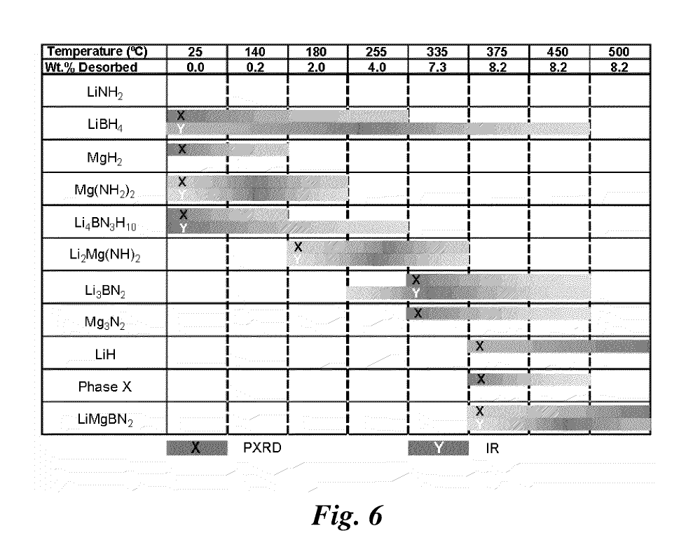

Phase identification: To determine the species involved in the various desorption reactions, phase composition studies are carried out for identically prepared samples that are desorbed to varying degrees to 1 bar hydrogen by heating at 5° C./min in a water displacement apparatus. Following desorption, each sample is quenched and analyzed using PXRD and IR. Results are summarized in FIG. 6.

The as-prepared sample (ball milling 2 g of LiNH₂, LiBH₄, and MgH₂ in a 2:1:1 ratio for 5 hours) contains two new species, Mg(NH₂)₂ and Li₄BN₃H₁₀, and no residual LiNH₂, which is indicative of milling-induced transformations. Residual MgH₂ and LiBH₄ starting materials are also apparent. Upon initial heating to 140° C., but before any appreciable amount of hydrogen is released, growth of Mg(NH₂)₂ and (weakly crystalline) LiH is detected. At the same time the diffraction peaks for Li₄BN₃H₁₀ disappear. As the characteristic symmetric and asymmetric amide N-H IR frequencies (3301 and 3242 cm⁻¹ observed, 3303 and 3243 cm⁻¹ reference) persist, it is suggestive that Li₄BN₃H₁₀ has melted. Further heating to 180° C. results in the release of 2.0 wt % hydrogen (1st low temperature event from FIG. 5) and the formation of Li₂Mg(NH)₂, based on its three characteristic peaks at 30.7°, 51.3°, and 60.9° in PXRD as well as the signature N-H stretch in the IR (3178 cm⁻¹ observed, 3187 cm⁻¹ reference). As illustrated through both PXRD and IR observations, this phase continues to grow in intensity until 255° C., corresponding to 4.0 wt % desorbed H₂. At this stage, MgH₂ and Mg(NH₂)₂ are substantially if not completely consumed while Li₄BN₃H₁₀ is significantly depleted.

The second major hydrogen releasing event occurs between 255° and 375° C. and corresponds to a total of 8.2 wt % hydrogen desorbed. During this stage Li₂Mg(NH)₂ and LiBH₄ are consumed while Mg₃N₂ and Li₃BN₂ are formed. From PXRD, trace amounts of LiH and an unknown phase (denoted as ‘Phase X’) are also detected. Continued heating to 500° C. does not produce additional hydrogen but rather an observed phase transformation consistent with the consumption of Li₃BN₂, Mg₃N₂, and LiBH₄ and the production of LiH and LiMgBN₂. The final hydrogen releasing step (>500° C.) is attributed to decomposition of LiH (3rd major event in FIG. 5).

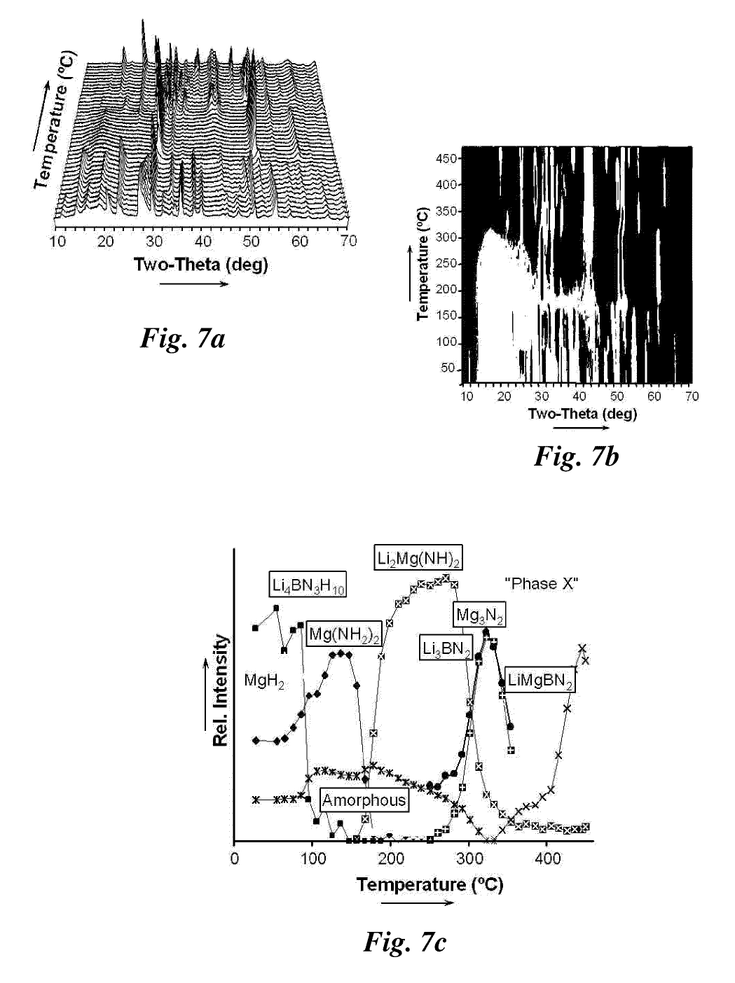

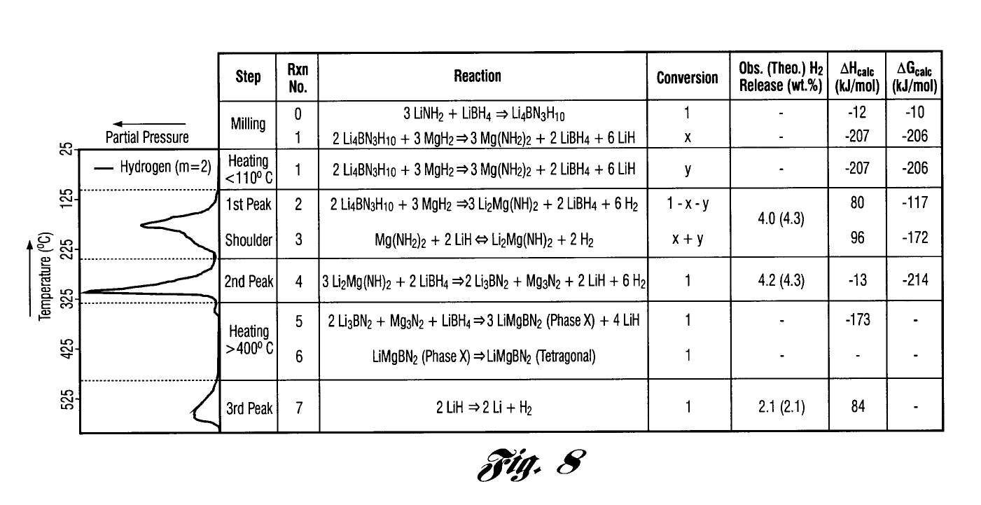

Variable-temperature in situ PXRD is used to validate above phase assignments, and to access phase transformation information. FIG. 7a shows the raw PXRD data as a function of temperature (25° to 450° C.) and FIG. 7b shows the two-dimensional contour plot.

The phase assemblage as a function of temperature is shown in FIG. 7c. The data reveal that the sequence and relative contribution of phases are identical to those observed with the static PXRD, thereby confirming proposed reaction sequence. Furthermore, the in situ data reveal that during initial heating of the as-prepared material, prior to any hydrogen release, Li₄BN₃H₁₀ and MgH₂ phases rapidly disappear by 100° and 150° C. respectively. The observed melting of Li₄BN₃H₁₀ at 100° C. occurs at a significantly lower temperature than the temperature of 150° C. previously reported. This low temperature melt may serve as an effective mass transfer medium or homogenizing agent, aiding in the distribution of Li₂Mg(NH)₂ (produced in the first desorption step reaction between Li₄BN₃H₁₀ and MgH₂), which would in turn serve as Li₂Mg(NH)₂ nucleation seeds for a second step reaction between Mg(NH₂)₂ and LiH. This ionic liquid therefore accelerates the desorption kinetics of the initial hydrogen release reactions.

Reaction pathway: Taking into account the observed and theoretical hydrogen capacity for each step, the reversible amount of stored hydrogen, and the phase compositions (obtained from both quenched/static and in situ PXRD and IR), a set of proposed reactions are summarized in FIG. 8.

The TPD-MS curve from FIG. 5 is incorporated to indicate the temperature region under which each reaction occurs. Also included in this table are the reaction enthalpies (DH_{calc}) and free energies (ΔG_{calc}) calculated at 300 K using density functional theory. The calculated free energies are observed to be negative and this suggests that the proposed reactions are thermodynamically reasonable.

During sample preparation, starting materials LiNH₂ and LiBH₄ react to form Li₄BN₃H₁₀. Subsequently, partial reaction of this quaternary phase with a portion of MgH₂ yields small amount of Mg(NH₂)₂

2Li₄BN₃H₁₀+3MgH₂→3Mg(NH₂)₂+2LiBH₄+6LiH (1)

As both reactions are exothermic based on DFT calculations, it is expected that they could occur under ball milling or upon moderate heating. After milling, the phases present include Li₄BN₃H₁₀, LiBH₄, MgH₂, Mg(NH₂)₂, and LiH. Upon subsequent heating (but before the onset of hydrogen release) production of Mg(NH₂)₂ continues via reaction 1.

Self-catalyzing mechanism: As the temperature reaches 100° C., Li₄BN₃H₁₀ melts and reacts with MgH₂ to form Li₂Mg(NH)₂, LiBH₄ and releases H₂ at the first low temperature desorption peak.

2Li₄BN₃H₁₀+3MgH₂→3Li₂Mg(NH)₂+2LiBH₄+6H₂ (2)

This reaction occurs only during desorption of the as-prepared material, and not in subsequent cycles (see Supporting Information). More importantly, reaction 2 serves to directly catalyze the subsequent reversible reaction between Mg(NH₂)₂ and LiH occurring at the shoulder region (approximately 190° to 230° C.).

Mg(NH₂)₂+2LiH→Li₂Mg(NH)₂+2H₂ (3)

The ternary composite is referred to as “self-catalyzed” in the sense that one reaction (reaction 2) pre-forms the product nuclei (Li₂Mg(NH)₂) for the subsequent reaction (reaction 3), resulting in enhancement of the overall kinetic properties. A separate study has confirmed the beneficial effects of product seeding in improving desorption kinetics of Mg(NH₂)₂ and LiH system.

It should be emphasized that the thermodynamics of the binary reactions between Mg(NH₂)₂ and LiH (reaction 3) indicate that it should proceed at a lower temperature than observed. The results suggest a new rational route, by which the kinetic properties of existing hydrogen desorption reactions can be enhanced, namely via coupled self-catalyzing reactions.

Higher-temperature reactions: As temperature is increased further, Li₂Mg(NH)₂ reacts with LiBH₄ to form Li₃BN₂, Mg₃N₂ and hydrogen (4.2 wt % observed, 4.3 wt % theoretical), which corresponds to the second peak.

3Li₂Mg(NH)₂+2LiBH₄→2Li₃BN₂+Mg₃N₂+2LiH+6H₂ (4)

This explains why the reversibility in this ternary system is sensitive to desorption temperature and desorbed hydrogen extent. When the sample is heated to above 350° C., Li₃BN₂, Mg₃N₂, and remaining LiBH₄ react to form ‘Phase X’ and tetragonal LiMgBN₂. On additional heating (to ˜450° C.), ‘Phase X’ is transformed completely into tetragonal LiMgBN₂. Finally, in the last high temperature hydrogen releasing step, LiH decomposed releasing an additional 2.1 wt % hydrogen (2.1 wt % theoretical).

Through a wide-ranging experimental and first-principle computational analysis, it is demonstrated that the self-catalyzing mechanism is believed to have arisen from a set of coupled, ancillary reactions yielding both a homogenizing ionic liquid phase and product nuclei for a subsequent reversible hydrogen storage reaction. These effects combine to yield enhanced low-temperature desorption kinetics and a significant reduction in ammonia liberation relative to the state-of-the-art binary constituent composites.

The samples that were used for the example and the evaluation techniques, are as follows:

Sample Preparation: Lithium amide (LiNH₂) (95% purity, Sigma-Aldrich), magnesium hydride (MgH₂) (95% purity, Gelest) and lithium borohydride (LiBH₄) (95% purity, Sigma-Aldrich) are used as received. All sample handling is performed in a MBraun Labmaster 130 glove box maintained under an argon atmosphere with <0.1 ppm O₂ and H₂O vapor. Binary composites, 2LiNH₂—LiBH₄, 2LiNH₂—MgH₂, and 2LiBH₄—MgH₂, were prepared according to literature protocol. For the ternary composite, two grams of LiNH₂, LiBH₄ and MgH₂ in a 2:1:1 molar ratio was loaded into a milling vial containing three stainless steel balls weighing 8.4 g each. Mechanical milling was carried out using a Spex 8000 high-energy mixer/mill for 1 hour to 20 hours.

Characterization and Property Evaluation: All methods relating to sample characterization and property evaluation including powder x-ray diffraction (PXRD), infrared spectroscopy (IR), kinetic hydrogen desorption/absorption studies (PCT, TPD-MS, and WDD), density functional theory (DFT) calculations, and activation energy calculations are described in detail in the Supporting Information.

### Kinetic Hydrogen Desorption and Absorption

TPD-MS: Variable temperature hydrogen desorption behavior and gas composition were measured using a Temperature-Programmed Desorption (TPD) apparatus constructed in-house utilizing a MKS PPT electron-ionization quadrupole mass-spectrometer (MS) equipped with a heated capillary inlet (115° C.), a Lindberg tube furnace with programmable temperature control and a Brooks 5850 E-series mass flow controller. For each experiment, a specimen of approximately 20 mg of the as-prepared sample was loaded into a quartz tube between quartz wool plugs in a glove box. The septa-sealed specimen tube was placed in the furnace and a continuous flow of UHP argon carrier gas (100 sccm flow rate) was passed through the specimen while it was heated at a programmed rate (1 to 10° C./min) from room temperature to the final set point (up to 600° C.). The concentrations of hydrogen (m/e=2) and ammonia (m/e=17) in the effluent were determined by comparison to single-point calibrations obtained using certified mixtures of 1% H₂/N₂ and 2.05% NH₃/N₂.

WDD: Hydrogen desorption kinetics were also characterized using a water displacement desorption (WDD) apparatus constructed in-house where the desorbed gas amount was directly monitored as a function of temperature. For each experiment, approximately 250 mg of sample was loaded into a stainless steel autoclave in a glove box. The sealed autoclave was mounted onto a three port manifold connected to UHP argon purge gas as well as an outlet tube which passes through the bottom of a water-filled graduated burette. The manifold and sample are purged with argon prior to each experiment. The sample is heated at a constant rate (1 to 10° C./min) from room temperature to the final set point (up to 450° C.) and the desorbed hydrogen volume (mL) manually monitored as the amount of water displaced in the burette. The amount of desorbed hydrogen was corrected for the reduced headspace pressure and thermal expansion of 1 bar argon gas upon sample heating. The total desorbed hydrogen amount from these experiments was confirmed by sample weight loss and PCT experiments.

PCT: Hydrogen desorption kinetics, reversibility, and cycling experiments were determined using a PCT Pro-2000 Sievert's type Pressure-Composition-Temperature (PCT) apparatus from Hy-Energy (Hy-Energy PCT Pro 2000, http://www.hy-energy.com). In a typical experiment, a 2 g sample was loaded into an autoclave sample holder having a thermocouple which penetrates into the interior of the sample. Temperatures and pressures of the sample and gas reservoirs were monitored by a LabView®-based control software. Absorption was performed at 140 to 230° C. using 100 bar UHP hydrogen. Desorption was performed using a 1 bar back pressure at temperatures ranging from 140° to 320° C.

### Powder X-Ray Diffraction (PXRD)

Static PXRD: Phase identity and purity was characterized by PXRD data collected on a SCINTAG (XDS 2) powder diffractometer operated at 45 kV and 40 mA with step increments of 0.02° measured during 2 s with Cu Kα radiation (λ=1.5418 Å). All samples were maintained under an argon atmosphere during data collection using a custom aluminum sample holder containing a Kapton® film cover and a depressed button-style sample pan. Samples were mounted into the sample pan, covered with a Parafilm® sheet, and sealed into the Al sample holder. Five peaks resulting from Parafilm® (2θ=21° and 24°) and Aluminum (2θ=38°, 45° and 65°) were manually excluded from the raw PXRD data files (in Supporting Information).

In-Situ PXRD: High-Temperature X-Ray diffraction data were collected using a Bueler HDK 2.4 furnace chamber attached to a Scintag X1 diffractometer, an Inel CPS 120 position sensitive detector and collimated Cu Kα radiation. Specimens were prepared in an inert atmosphere glove box by spreading powder onto a sapphire crystal with a drop of a Vaseline/pentane mixture impregnated into the powder and then stored in a sealed container to protect the powder against exposure to room air during transfer into the HTXRD chamber. Once the specimen was placed onto the heating strip and the furnace chamber was sealed, the atmosphere inside the chamber was evacuated and backfilled with nitrogen several times to eliminate residual oxygen and moisture. Data were collected under an atmosphere of flowing purified nitrogen (200 sccm) while the temperature was ramped at a continuous rate of 2° C./min from 50-450° C. following an initial room temperature scan. Scans were integrated for 5 minutes, each corresponding to a temperature average over a 10° C. window while ramping. The phase assemblage was determined for each scan using the MDI JADE software and the Powder Diffraction File (sets 1-51). In some cases, a phase ID was not possible and the composition of the unknown phase could only be inferred. In addition, the presence of transient liquid phases made a complete quantitative analysis impossible and phase assemblages presented here are from tracking the net intensities of representative peaks for each phase.

### Infrared Spectroscopy (IR)

Photo-acoustic infrared spectra were obtained on a Mattson Instruments Cygnus 100 FT-IR spectrometer. This unit was equipped with a water cooled source and an ancillary 75 Hz high pass filter. An MTEC 200 PAS cell was used with a KBr window. The two turning mirrors used to direct the interferometer light onto the sample have been changed so as to transfer all of the light passed by the source, the 50% instrument iris aperture onto the sample. 32 sample and 64 background scans were collected. Carbon black powder was used as the reference material in the background. The instrument was purged with the boil-off liquid nitrogen, while the cell was purged with UHP helium. A glove bag was taped to the access panel on the instrument to operate as an air lock for the air sensitive samples. The interferometer mirror velocity used was 0.08 cm/sec. All data manipulations and transformations were accomplished with Mattson WinFirst software.

### Density Functional Theory (DFT) Calculations

Calculations of finite-temperature thermodynamic quantities—enthalpies, entropies, and free energies—were performed using density functional theory in conjunction with the harmonic approximation (VASP code). The projector augmented wave method was used to describe the core-valence interaction, and the exchange-correlation energy was evaluated using the PW91 generalized gradient approximation (D. J. Siegel, C. Wolverton, and V. Ozolins, Phys. Rev. B 2007, 75, 014101).

### Activation Energy Calculations

The activation energies (Eₐ) for reactions (2) and (4) were estimated to be 119 and 184 kJ/mol respectively. These data were determined using the Kissinger and Gao & Wang methods. For the Kissinger method, Eₐ is extracted from the slope of the line generated from plotting ln(β/Tₘ²) versus Tₘ⁻¹ (H. E. Kissinger, Anal. Chem. 1957, 29, 1702-1706). In this relation, β is the heating rate (2 to 10 K/min) and Tₘ the peak reaction (desorption) temperature. These values were corroborated using the Gao and Wang model, a linear relation between ln(dX/dt)ₚ and 1000/Tₚ whose slope is related to Eₐ (Y. Gao, W. Wang, J. Non-Cryst. Solids 1986, 81, 129-134). Here, (dX/dt)ₚ is the peak rate of reaction and Tₚ the peak reaction temperature.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A method of enhancing the kinetic properties of a hydrogen storage composition by implementing a self-catalyzing reaction mechanism, the method comprising:
formulating a hydrogen desorption pathway in a hydrogen storage composition, the pathway including at least one hydrogen releasing reaction and at least one ancillary reaction; and
selecting at least one of the ancillary reactions to produce at least one product or effect that serves to enhance the kinetic properties of at least one of the hydrogen releasing reactions.

2. The method of claim 1, wherein the product of an ancillary reaction serves as a catalyst in the primary hydrogen storage reaction via reduction of kinetic barriers.

3. The method of claim 1, wherein the product of an ancillary reaction serves as a microstructural facilitator for the hydrogen storage reaction in preventing product grain growth as to aid in mass transfer.

4. The method of claim 1, further comprising selecting a second ancillary reaction to produce a homogenizing agent for enhancing the kinetic properties of the hydrogen releasing reaction.

5. The method of claim 1, further comprising selecting a second ancillary reaction to produce heat for enhancing the kinetic properties of the hydrogen releasing reaction.

6. The method of claim 1, further comprising selecting a second ancillary reaction to produce a plurality of product nucleation seeds for enhancing the kinetic properties of the hydrogen releasing reaction.

7. The method of claim 4, wherein the homogenizing agent is a liquid phase with a melting temperature of about 25° C. to about 200° C.

8. The method of claim 4, wherein the homogenizing agent is an ionic liquid with a melting temperature of about 70° C. to about 120° C.

9. A method of enhancing the kinetic properties of a hydrogen storage composition by implementing a self-catalyzing reaction mechanism, the method comprising:
formulating a hydrogen absorption pathway in a hydrogen storage composition, the pathway including a hydrogen uptake reaction and an ancillary reaction; and
selecting the ancillary reaction to produce a product or effect that serves to enhance the kinetic properties of the hydrogen uptake reaction.

10. The method of claim 9, wherein the hydrogen storage composition consists essentially of LiNH₂, LiBH₄, and MgH₂.

11. The method of claim 9, wherein the hydrogen uptake reaction is reversible.

12. The method of claim 9, wherein the hydrogen storage composition comprises a hydride selected from the group consisting of conventional hydrides and complex hydrides.

13. The method of claim 9, wherein the hydrogen storage composition comprises both conventional hydrides and complex hydrides.

14. The method of claim 9, wherein the selecting step comprises selecting the ancillary reaction to produce heat for enhancing the kinetic properties of the hydrogen uptake reaction.

15. The method of claim 9, wherein the selecting step comprises selecting the ancillary reaction to produce a homogenizing agent for enhancing the kinetic properties of the hydrogen uptake reaction.

16. The method of claim 9, wherein the selecting step comprises selecting the ancillary reaction to produce a plurality of product nucleation seeds for enhancing the kinetic properties of the hydrogen uptake reaction.

17. The method of claim 9, wherein the selecting step comprises selecting the ancillary reaction to produce a disbursed catalyst for enhancing the kinetic properties of the hydrogen uptake reaction.

18. The method of claim 9, wherein the selecting step comprises selecting the ancillary reaction to produce a microstructural facilitator for enhancing the kinetic properties of the hydrogen uptake reaction.

19. The method of claim 16, wherein the product nucleation seeds comprise a material that is chemically identical to a product of the hydrogen uptake reaction.

20. The method of claim 16, wherein the product nucleation seeds comprise Li₂Mg(NH)₂.

21. The method of claim 16, wherein the homogenizing agent comprises Li₄BN₃H₁₀.

22. A method of enhancing the kinetic properties of a hydrogen storage composition by implementing a self-catalyzing reaction mechanism, the method comprising:
formulating a hydrogen pathway in a hydrogen storage composition, the pathway including a hydrogen releasing reaction, a hydrogen uptake reaction, and a plurality of ancillary reactions; and
selecting at least one of the ancillary reactions to produce a product that serves to enhance the kinetic properties of at least one of the hydrogen releasing reaction or the hydrogen uptake reaction.
